(19) United States
(12) Patent Application Publication
(10) Pub. No.: US 2024/0365208 A1
(43) Pub. Date: Oct. 31, 2024

(54) COMMUNICATION CONTROL METHOD

(71) Applicant: KYOCERA Corporation, Kyoto (JP)

(72) Inventor: Masato FUJISHIRO, Yokohama-shi (JP)

(73) Assignee: KYOCERA Corporation, Kyoto (JP)

(21) Appl. No.: 18/764,597

(22) Filed: Jul. 5, 2024

Related U.S. Application Data
(63) Continuation of application No. PCT/JP2022/047873, filed on Dec. 26, 2022.

(30) Foreign Application Priority Data
Jan. 7, 2022 (JP) 2022-001821

(51) Int. Cl. H04W 40/22; H04W 40/34; H04W 84/04

(52) U.S. Cl. CPC H04W 40/22; H04W 40/34; H04W 84/047

(57) ABSTRACT

In a first aspect, a communication control method is used in a cellular communication system. The communication control method includes configuring, at a donor node, association information of a first routing ID included in a packet and a second routing ID indicating an output destination for a relay node. The communication control method includes transmitting, at the relay node, the packet to at least one of a first relay node on a first path indicated by the first routing ID or a second relay node on a second path indicated by the second routing ID, in accordance with the association information.

### RELATED APPLICATIONS

The present application is a continuation based on PCT Application No. PCT/JP2022/047873, filed on Dec. 26, 2022, which claims the benefit of Japanese Patent Application No. 2022-001821 filed on Jan. 7, 2022. The content of which is incorporated by reference herein in their entirety.

### TECHNICAL FIELD

The present disclosure relates to a communication control method used in a cellular communication system.

### BACKGROUND

The Third Generation Partnership Project (3GPP), which is a standardization project of a cellular communication system, has studied introduction of a new relay node referred to as an Integrated Access and Backhaul (IAB) node (see, for example, Non-Patent Document 1). One or more relay nodes are involved in communication between a base station and a user equipment and perform relay for the communication.

### CITATION LIST

### Non-Patent Literature

Non-Patent Document 1: 3GPP TS 38.300 V16.8.0 (2021-12)

### SUMMARY

In a first aspect, a communication control method is used in a cellular communication system. The communication control method includes configuring, at a donor node, association information of a first routing ID included in a packet and a second routing ID indicating an output destination, for a relay node. The communication control method includes transmitting, at the relay node, the packet to at least one of a first relay node on a first path indicated by the first routing ID or a second relay node on a second path indicated by the second routing ID in accordance with the association information.

### BRIEF DESCRIPTION OF THE DRAWINGS

FIG. 1 is a diagram illustrating a configuration example of a cellular communication system according to an embodiment.

FIG. 2 is a diagram illustrating a relationship between an IAB node, parent nodes, and child nodes.

FIG. 3 is a diagram illustrating a configuration example of a gNB (base station) according to an embodiment.

FIG. 4 is a diagram illustrating a configuration example of an IAB node (relay node) according to an embodiment.

FIG. 5 is a diagram illustrating a configuration example of a UE (user equipment) according to an embodiment.

FIG. 6 is a diagram illustrating an example of a protocol stack related to an RRC connection and a NAS connection of an IAB-MT.

FIG. 7 is a diagram illustrating an example of a protocol stack related to an F1-U protocol.

FIG. 8 is a diagram illustrating an example of a protocol stack related to an F1-C protocol.

FIG. 9 is a diagram illustrating a configuration example of “PDCP-based DAPS-like” according to a first embodiment.

FIG. 10 is a diagram illustrating a configuration example of “BAP-based DAPS-like” according to the first embodiment.

FIG. 11 is a diagram illustrating an operation example according to the first embodiment.

FIG. 12 is a diagram illustrating an operation example according to a second embodiment.

### DESCRIPTION OF EMBODIMENTS

An object of the present disclosure is to appropriately disperse a load. The present disclosure aims to suppress interruption of a service.

A cellular communication system in an embodiment will be described with reference to the drawings. In the description of the drawings, the same or similar parts are denoted by the same or similar reference signs.

### Configuration of Cellular Communication System

A configuration example of the cellular communication system according to an embodiment will be described. In an embodiment, a cellular communication system 1 is a 3GPP 5G system. Specifically, a radio access scheme in the cellular communication system 1 is New Radio (NR) being a 5G radio access scheme. Note that Long Term Evolution (LTE) may be at least partially applied to the cellular communication system 1. A future cellular communication system such as 6G may be applied to the cellular communication system 1.

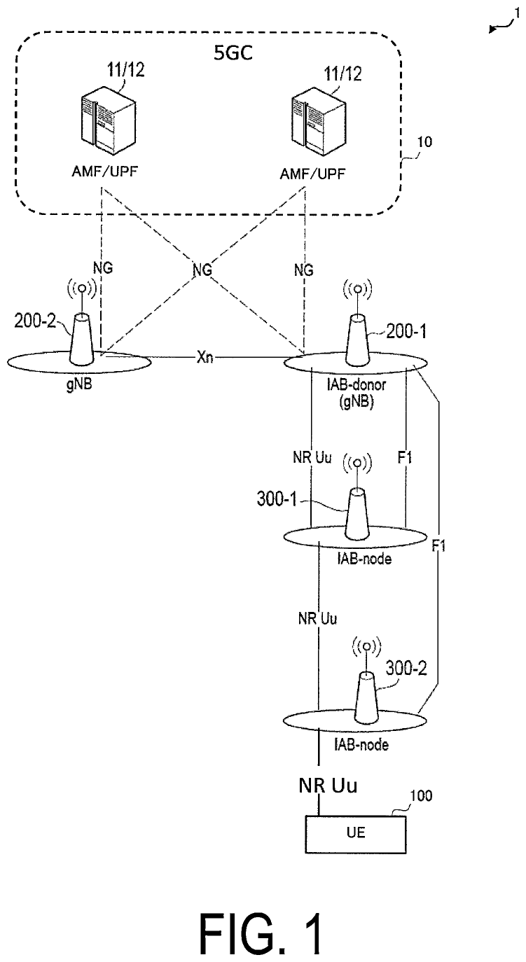

FIG. 1 is a diagram illustrating a configuration example of the cellular communication system 1 according to an embodiment.

As illustrated in FIG. 1, the cellular communication system 1 includes a 5G core network (5GC) 10, a User Equipment (UE) 100, base station apparatuses (hereinafter, also referred to as “base stations” in some cases) 200-1 and 200-2, and IAB nodes 300-1 and 300-2. The base station 200 may be referred to as a gNB.

An example in which the base station 200 is an NR base station is mainly described below, but the base station 200 may also be an LTE base station (i.e., an eNB).

Note that hereinafter, the base stations 200-1 and 200-2 may be referred to as a gNB 200 (or the base station 200 in some cases), and the IAB nodes 300-1 and 300-2 may be referred to as an IAB node 300.

The 5GC 10 includes an Access and Mobility Management Function (AMF) 11 and a User Plane Function (UPF) 12. The AMF 11 is an apparatus that performs various types of mobility controls and the like for the UE 100. The AMF 11 communicates with the UE 100 by using Non-Access Stratum (NAS) signaling, and thereby manages information of an area in which the UE 100 exists. The UPF 12 is an apparatus that performs transfer control of user data and the like.

Each gNB 200 is a fixed wireless communication node and manages one or more cells. The term “cell” is used to indicate a minimum unit of a wireless communication area. The term “cell” may be used to indicate a function or a resource for performing wireless communication with the UE 100. One cell belongs to one carrier frequency. Hereinafter, the cell and the base station may be used without distinction.

Each gNB 200 is interconnected to the 5GC 10 via an interface referred to as an NG interface. FIG. 1 illustrates a gNB 200-1 and a gNB 200-2 that are connected to the 5GC 10.

Each gNB 200 may be divided into a Central Unit (CU) and a Distributed Unit (DU). The CU and the DU are interconnected via an interface referred to as an F1 interface. An F1 protocol is a communication protocol between the CU and the DU and includes an F1-C protocol that is a control plane protocol and an F1-U protocol that is a user plane protocol.

The cellular communication system 1 supports an IAB that uses NR for the backhaul to enable wireless relay of the NR access. The donor gNB 200-1 (or a donor node, which hereinafter may be also referred to as a “donor node”) is a donor base station that is a terminal node of the NR backhaul on the network side and includes additional functionality for supporting the IAB. The backhaul can implement multi-hop via a plurality of hops (i.e., a plurality of IAB nodes 300).

FIG. 1 illustrates an example in which the IAB node 300-1 is wirelessly connected to the donor node 200-1, the IAB node 300-2 is wirelessly connected to the IAB node 300-1, and the F1 protocol is transmitted in two backhaul hops.

The UE 100 is a mobile wireless communication apparatus that performs wireless communication with the cells. The UE 100 may be any type of apparatus as long as the UE 100 is an apparatus that performs wireless communication with the gNB 200 or the IAB node 300. For example, the UE 100 includes a mobile phone terminal, a tablet terminal, a laptop PC, a sensor or an apparatus that is provided in a sensor, a vehicle or an apparatus that is provided in a vehicle, and an aircraft or an apparatus provided in an aircraft. The UE 100 is wirelessly connected to the IAB node 300 or the gNB 200 via an access link. FIG. 1 illustrates an example in which the UE 100 is wirelessly connected to the IAB node 300-2. The UE 100 indirectly communicates with the donor node 200-1 via the IAB node 300-2 and the IAB node 300-1.

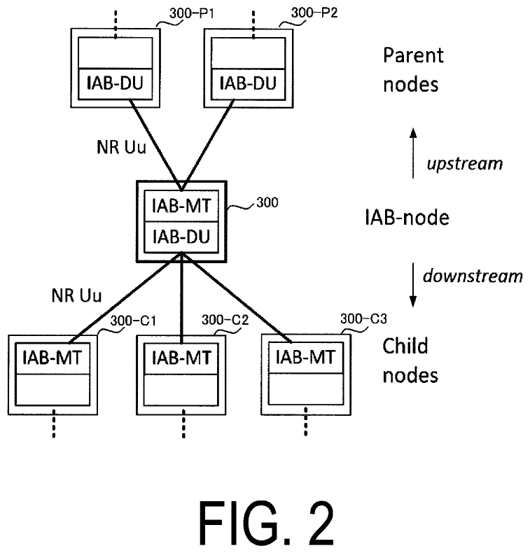

FIG. 2 is a diagram illustrating an example of a relationship between the IAB node 300, Parent nodes, and Child nodes.

As illustrated in FIG. 2, each IAB node 300 includes an IAB-DU corresponding to a base station functional unit and an IAB-Mobile Termination (IAB-MT) corresponding to a user equipment functional unit.

Neighboring nodes of the IAB-MT (i.e., upper node) of an NR Uu wireless interface are referred to as “parent nodes”. The parent node is the DU of a parent IAB node or the donor node 200. A radio link between the IAB-MT and each parent node is referred to as a backhaul link (BH link). FIG. 2 illustrates an example in which the parent nodes of the IAB node 300 are IAB nodes 300-P1 and 300-P2. Note that the direction toward the parent nodes is referred to as upstream. As viewed from the UE 100, the upper nodes of the UE 100 can correspond to the parent nodes.

Neighboring nodes of the IAB-DU (i.e., lower nodes) of an NR access interface are referred to as “child nodes”. The IAB-DU manages cells in a manner the same as, and/or similar to the gNB 200. The IAB-DU terminates the NR Uu wireless interface connected to the UE 100 and the lower IAB nodes. The IAB-DU supports the F1 protocol for the CU of the donor node 200-1. FIG. 2 illustrates an example in which the child nodes of the IAB node 300 are IAB nodes 300-C1 to 300-C3; however, the UE 100 may be included in the child nodes of the IAB node 300. Note that the direction toward the child nodes is referred to as downstream.

All of the IAB nodes 300 connected to the donor node 200 via one or more hops form a Directed Acyclic Graph (DAG) topology (which may be referred to as “topology” below) routed at the donor node 200. In this topology, the neighboring nodes of the IAB-DU in the interface are child nodes, and the neighboring nodes of the IAB-MT in the interface are parent nodes as illustrated in FIG. 2. The donor node 200 performs, for example, centralized management on resources, topology, and routes of the IAB topology. The donor node 200 is a gNB that provides network access to the UE 100 via a network of backhaul links and access links.

### Configuration of Base Station

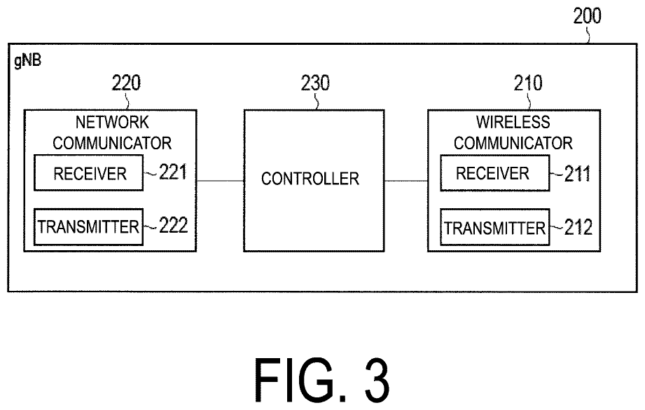

A configuration of the gNB 200 that is a base station according to the embodiment will be described. FIG. 3 is a diagram illustrating a configuration example of the gNB 200. As illustrated in FIG. 3, the gNB 200 includes a wireless communicator 210, a network communicator 220, and a controller 230.

The wireless communicator 210 performs wireless communication with the UE 100 and performs wireless communication with the IAB node 300. The wireless communicator 210 includes a receiver 211 and a transmitter 212. The receiver 211 performs various types of reception under control of the controller 230. The receiver 211 includes an antenna, and converts (down-converts) a radio signal received by the antenna into a baseband signal (reception signal) which is then output to the controller 230. The transmitter 212 performs various types of transmission under control of the controller 230. The transmitter 212 includes an antenna, and converts (up-converts) the baseband signal (transmission signal) output by the controller 230 into a radio signal which is then transmitted from the antenna.

The network communicator 220 performs wired communication (or wireless communication) with the 5GC 10 and performs wired communication (or wireless communication) with another neighboring gNB 200. The network communicator 220 includes a receiver 221 and a transmitter 222. The receiver 221 performs various types of reception under control of the controller 230. The receiver 221 receives a signal from an external source and outputs the reception signal to the controller 230. The transmitter 222 performs various types of transmission under control of the controller 230. The transmitter 222 transmits the transmission signal output by the controller 230 to an external destination.

The controller 230 performs various types of controls for the gNB 200. The controller 230 includes at least one memory and at least one processor electrically connected to the memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. The processor performs processing of the layers described below. Note that the controller 230 may perform each processing and each operation in the gNB 200 in each embodiment to be described below.

### Configuration of Relay Node

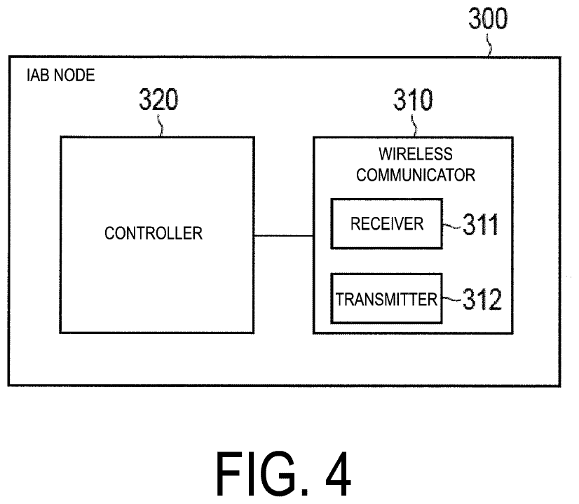

A configuration of the IAB node 300 that is a relay node (or a relay node apparatus, which may be also referred to as a “relay node” below) according to the embodiment will be described. FIG. 4 is a diagram illustrating a configuration example of the IAB node 300. As illustrated in FIG. 4, the IAB node 300 includes a wireless communicator 310 and a controller 320. The IAB node 300 may include a plurality of wireless communicators 310.

The wireless communicator 310 performs wireless communication with the gNB 200 (BH link) and wireless communication with the UE 100 (access link). The wireless communicator 310 for the BH link communication and the wireless communicator 310 for the access link communication may be provided separately.

The wireless communicator 310 includes a receiver 311 and a transmitter 312. The receiver 311 performs various types of reception under control of the controller 320. The receiver 311 includes an antenna, and converts (down-converts) a radio signal received by the antenna into a baseband signal (reception signal) which is then transmitted to the controller 320. The transmitter 312 performs various types of transmission under control of the controller 320. The transmitter 312 includes an antenna, and converts (up-converts) the baseband signal (transmission signal) output by the controller 320 into a radio signal which is then transmitted from the antenna.

The controller 320 performs various types of controls in the IAB node 300. The controller 320 includes at least one memory and at least one processor electrically connected to the memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. The processor performs processing of the layers described below. Note that the controller 320 may perform each processing and each operation in the IAB node 300 in each embodiment to be described below.

### Configuration of User Equipment

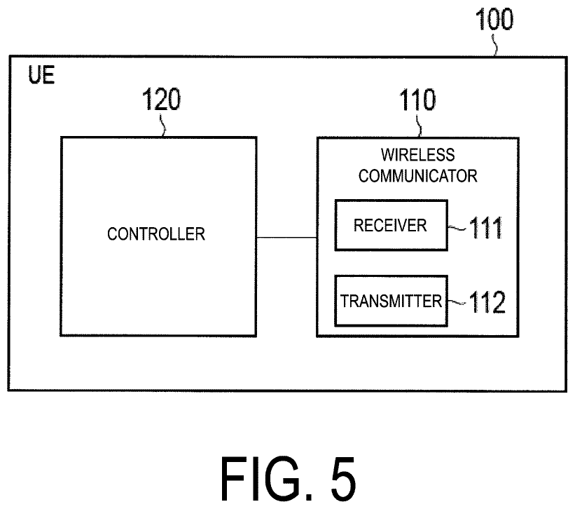

A configuration of the UE 100 that is a user equipment according to the embodiment will be described. FIG. 5 is a diagram illustrating a configuration example of the UE 100. As illustrated in FIG. 5, the UE 100 includes a wireless communicator 110 and a controller 120.

The wireless communicator 110 performs wireless communication in the access link, i.e., wireless communication with the gNB 200 and wireless communication with the IAB node 300. The wireless communicator 110 may also perform wireless communication in a sidelink, i.e., wireless communication with another UE 100. The wireless communicator 110 includes a receiver 111 and a transmitter 112. The receiver 111 performs various types of reception under control of the controller 120. The receiver 111 includes an antenna and converts (down-converts) a radio signal received by the antenna into a baseband signal (reception signal) which is then output to the controller 120. The transmitter 112 performs various types of transmission under control of the controller 120. The transmitter 112 includes an antenna and converts (up-converts) the baseband signal (transmission signal) output by the controller 120 into a radio signal which is then transmitted from the antenna.

The controller 120 performs various types of control in the UE 100. The controller 120 includes at least one memory and at least one processor electrically connected to the memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. The processor performs processing of the layers described below. Note that the controller 120 may perform each processing in the UE 100 in each embodiment described below.

### Configuration of Protocol Stack

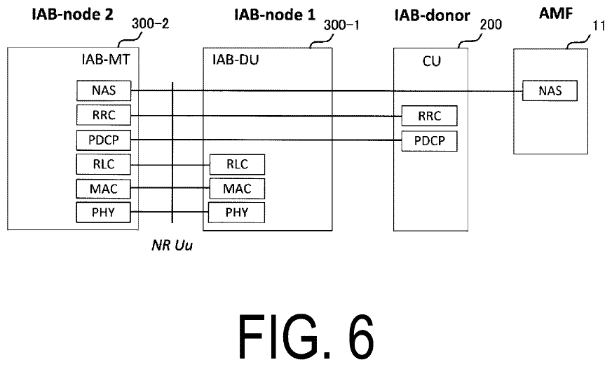

A configuration of a protocol stack according to the embodiment will be described. FIG. 6 is a diagram illustrating an example of a protocol stack related to an RRC connection and a NAS connection of the IAB-MT.

As illustrated in FIG. 6, the IAB-MT of the IAB node 300-2 includes a physical (PHY) layer, a Medium Access Control (MAC) layer, a Radio Link Control (RLC) layer, a Packet Data Convergence Protocol (PDCP) layer, a Radio Resource Control (RRC) layer, and a Non-Access Stratum (NAS) layer.

The PHY layer performs coding and decoding, modulation and demodulation, antenna mapping and demapping, and resource mapping and demapping. Data and control information are transmitted between the PHY layer of the IAB-MT of the IAB node 300-2 and the PHY layer of the IAB-DU of the IAB node 300-1 via a physical channel.

The MAC layer performs priority control of data, retransmission processing through hybrid ARQ (HARQ: Hybrid Automatic Repeat reQuest), a random access procedure, and the like. Data and control information are transmitted between the MAC layer of the IAB-MT of the IAB node 300-2 and the MAC layer of the IAB-DU of the IAB node 300-1 via a transport channel. The MAC layer of the IAB-DU includes a scheduler. The scheduler determines uplink and downlink transport formats (transport block sizes, Modulation and Coding Schemes (MCSs)) and allocated resource blocks.

The RLC layer transmits data to the RLC layer on the reception side by using functions of the MAC layer and the PHY layer. Data and control information are transmitted between the RLC layer of the IAB-MT of the IAB node 300-2 and the RLC layer of the IAB-DU of the IAB node 300-1 via a logical channel.

The PDCP layer performs header compression and decompression, and encryption and decryption. Data and control information are transmitted between the PDCP layer of the IAB-MT of the IAB node 300-2 and the PDCP layer of the donor node 200 via a radio bearer.

The RRC layer controls a logical channel, a transport channel, and a physical channel according to establishment, re-establishment, and release of a radio bearer. RRC signaling for various configurations is transmitted between the RRC layer of the IAB-MT of the IAB node 300-2 and the RRC layer of the donor node 200. When an RRC connection to the donor node 200 is present, the IAB-MT is in an RRC connected state. When no RRC connection to the donor node 200 is present, the IAB-MT is in an RRC idle state.

The NAS layer which is positioned higher than the RRC layer performs session management, mobility management, and the like. NAS signaling is transmitted between the NAS layer of the IAB-MT of the IAB node 300-2 and the AMF 11.

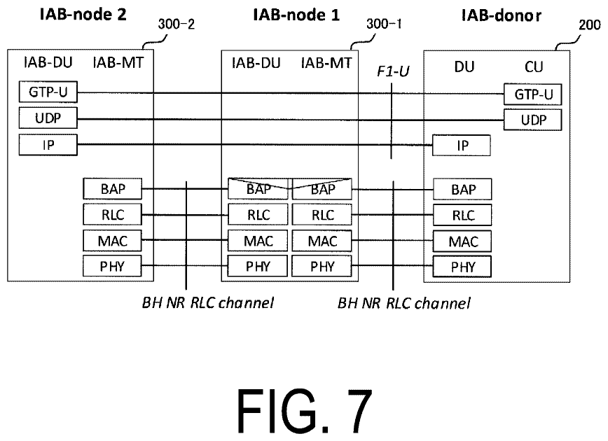

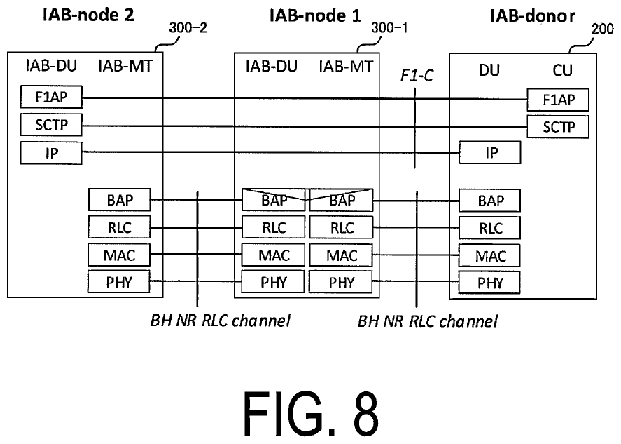

FIG. 7 is a diagram illustrating a protocol stack related to an F1-U protocol. FIG. 8 is a diagram illustrating a protocol stack related to an F1-C protocol. An example is illustrated in which the donor node 200 is divided into a CU and a DU.

As illustrated in FIG. 7, each of the IAB-MT of the IAB node 300-2, the IAB-DU of the IAB node 300-1, the IAB-MT of the IAB node 300-1, and the DU of the donor node 200 includes a Backhaul Adaptation Protocol (BAP) layer as an upper layer of the RLC layer. The BAP layer performs routing processing, and bearer mapping and demapping processing. In the backhaul, the IP layer is transmitted via the BAP layer to allow routing through a plurality of hops.

In each backhaul link, a Protocol Data Unit (PDU) of the BAP layer is transmitted by the backhaul RLC channel (BH NR RLC channel). Configuring a plurality of backhaul RLC channels in each BH link enables the prioritization and Quality of Service (QOS) control of traffic. The association between the BAP PDU and the backhaul RLC channel is executed by the BAP layer of each IAB node 300 and the BAP layer of the donor node 200.

As illustrated in FIG. 8, the protocol stack of the F1-C protocol includes an F1AP layer and an SCTP layer instead of a GTP-U layer and a UDP layer illustrated in FIG. 7.

Note that in the description below, processing or operation performed by the IAB-DU and the IAB-MT of the IAB may be simply described as processing or operation of the “IAB”. For example, in the description, transmitting, by the IAB-DU of the IAB node 300-1, a message of the BAP layer to the IAB-MT of the IAB node 300-2 is assumed to correspond to transmitting, by the IAB node 300-1, the message to the IAB node 300-2. Processing or operation of the DU or CU of the donor node 200 may be described simply as processing or operation of the “donor node”.

An upstream direction and an uplink (UL) direction may be used without distinction. A downstream direction and a downlink (DL) direction may be used without distinction.

### First Embodiment

A first embodiment will be described.

### Regarding “DAPS-like”

3GPP has introduced Dual Active Protocol Stack Hand Over (DAPS HO) from Release-16. DAPS HO is a handover procedure of maintaining connection with a source gNB until connection with a source cell is released after succeeding in random access to a target gNB. A UE maintains connection with the source gNB until random access with the target gNB succeeds. Thus, for example, DAPS HO can cause the UE to suppress service interruption due to HO.

It is argued for 3GPP to apply a solution of DAPS HO to IAB. Such a solution may be referred to as a “DAPS-like solution” (or “DAPS-like”).

For example, a scenario is considered for applying “DAPS-like” to migration of a parent node 300-P of the IAB node 300 or Conditional HandOver (CHO). It can be said that such a scenario is a scenario for switching connection of the IAB node 300 using “DAPS-like”.

On the other hand, it is also argued to use “DAPS-like” for load dispersion in a topology. For example, a plurality of paths may be configured in advance to the IAB node 300, and a predetermined packet is transferred to the plurality of paths. Thus, the load due to packet transfer concentrated on a specific path can be dispersed. Load dispersion can suppress service interruption to the UE 100.

Generally, a CU of the donor node 200 performs a routing configuration to the IAB-DU of each IAB node 300 in the same topology. A BAP entity (or a BAP layer. Hereinafter, an “entity” and a “layer” may be used without being distinguished from each other) in the IAB-DU of each IAB node 300 transmits a BAP packet received from a previous hop or an upper layer to a next hop in accordance with the routing configuration.

A scenario is also considered for achieving the load dispersion described above by updating (or changing) the routing configuration.

However, when the routing configuration is updated, various problems may occur. When, for example, a time is taken to update the routing configuration, the topology includes multiple packets transferred using the routing configuration before the update. When the updated routing configuration is applied to such a packet, erroneous transmission may occur.

Accordingly, load dispersion is desirably performed without updating the routing configuration.

“DAPS-like” generally has the following two types.
Option A) PDCP-based DAPS-like
Option B) BAP-based DAPS-like

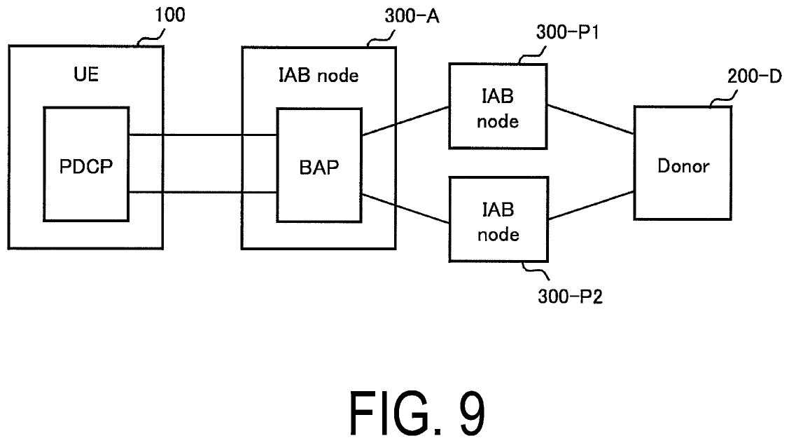

FIG. 9 is a diagram illustrating a configuration example of “PDCP-based DAPS-like” (hereinafter, referred to as an “option A”) according to the first embodiment. In FIG. 9, an IAB node 300-A is also an access IAB node. The access IAB node is a node that first processes packets received from the UE 100, and a node that lastly processes packets transmitted to the UE 100.

In the option A, two paths are established on a PDCP link between a PDCP entity of the UE 100 and a PDCP entity of the donor node 200. For example, the UE 100 configures an entity group (first entity group) from a PHY entity to an RLC entity, and an entity group (second entity group) from another PHY entity to the RLC entity is configured. The UE 100 includes the two entity groups. The RLC entity of the first entity group transmits an RLC packet to the IAB node 300-A, and the RLC entity of the second entity group transmits the RLC packet to the IAB node 300-A. Thus, for packet transfer in an upstream direction, as illustrated in FIG. 9, packets can be transferred via the two paths between the UE 100 and the IAB node 300-A (access IAB node).

Note that configuring the two entity groups in this manner may be referred to as an “existing DAPS HO function”.

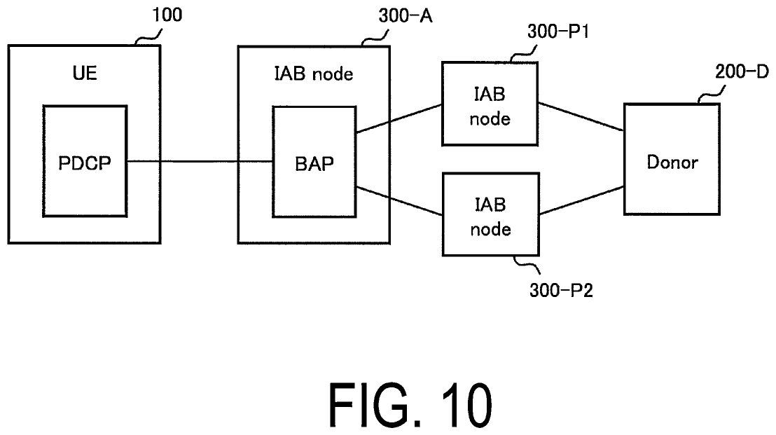

On the other hand, FIG. 10 is a diagram illustrating a configuration example of “BAP-based DAPS-like” (hereinafter, referred to as an “option B”) according to the first embodiment.

The option B is an example in which the existing DAPS HO function is ported to the BAP entity of the IAB node 300-A, and the two paths are established between the BAP layer of the IAB node 300-A and the BAP layer of the donor node 200. Unlike the option A, the two entity groups are not configured at the UE 100 in the option B. Thus, in the option B, only one path is established between the UE 100 and the IAB node 300-A (access IAB node).

Comparing the two options, while the same packet is transmitted twice between the UE 100 and the access IAB node 300-A in the option A, the same packet may be transmitted once in the option B. Therefore, the option A has a problem in that packet transmission efficiency is not good as compared with that of the option B. Note that the examples of the option A and the option B described above are examples of the upstream direction. However, in a case of a downstream direction, the donor node 200 transmits the same packet twice in both of the option A and the option B.

The option A also has a problem in that, if the UE 100 does not support DAPS HO, the option A itself cannot be executed. DAPS HO is originally a function for handover and does not assume the load dispersion described above.

The option B will be described in the first embodiment.

Hereinafter, “DAPS-like” will be referred to as Route Aggregation. Hereinafter, a case where “DAPS-like” is used for load dispersion will be described. However, such a case may also be described as a case included in the term “route aggregation”.

According to route aggregation, different packets may be transmitted via a plurality of paths. That is, route aggregation has a feature of Carrier Aggregation. According to route aggregation, different packets may be transmitted via a plurality of next hop nodes. That is, route aggregation has a feature of Dual Connectivity. According to route aggregation, the same packet may be duplicated and transmitted via a plurality of routes, a plurality of parent nodes, or a plurality of child nodes. That is, route aggregation has a feature of Packet Duplication. As described above, route aggregation has a feature similar to those of the existing technologies.

Route aggregation has a feature similar to those of the existing IAB technologies. That is, according to route aggregation, different packets may be transmitted via a plurality of routes or a plurality of next hop nodes. This is also a feature of routing. According to route aggregation, the same packet may be transmitted via a plurality of routes or a plurality of next hop nodes without being duplicated. This is also a feature of local rerouting.

As described above, it can be said that route aggregation has features of the existing technologies.

### Communication Control Method According to First Embodiment

A communication control method related to route aggregation will be described. The first embodiment will describe an example in which routing IDs are bundled and associated with each other, and route aggregation is performed using the associated routing IDs.

More specifically, firstly, a donor node (e.g., donor node 200) configures association information of a first routing ID included in a packet and a second routing ID indicating an output destination for a relay node (e.g., IAB node 300-A). Secondly, the relay node transmits the packet to at least one of the first relay node (e.g., IAB node 300-P1) on the first path indicated by the first routing ID or the second relay node (e.g., IAB node 300-P2) on the second path indicated by the second routing ID in accordance with the association information.

Thus, the packet is transmitted in at least one direction of the first path indicated by the first routing ID and the second path indicated by the second routing ID, so that packet transfer is not concentrated on one path, and a load can be appropriately dispersed. The IAB node 300 transmits a packet in accordance with the association information, so that even the UE 100 that does not support DAPS HO can achieve load dispersion. The donor node 200 configures the association information to the IAB node 300, so that the load dispersion can be achieved without updating the routing configuration. By appropriately achieving the load dispersion in this way, service interruption for the UE 100 can be suppressed.

Hereinafter, a BAP routing ID may be also referred to as a routing ID. The routing ID is composed of a BAP address and a BAP path ID. The BAP address indicates a destination node of the packet. The BAP path ID indicates a routing path through which the packet travels to the destination node. Hereinafter, the BAP path ID may be referred to as a path ID.

### Operation Example According to First Embodiment

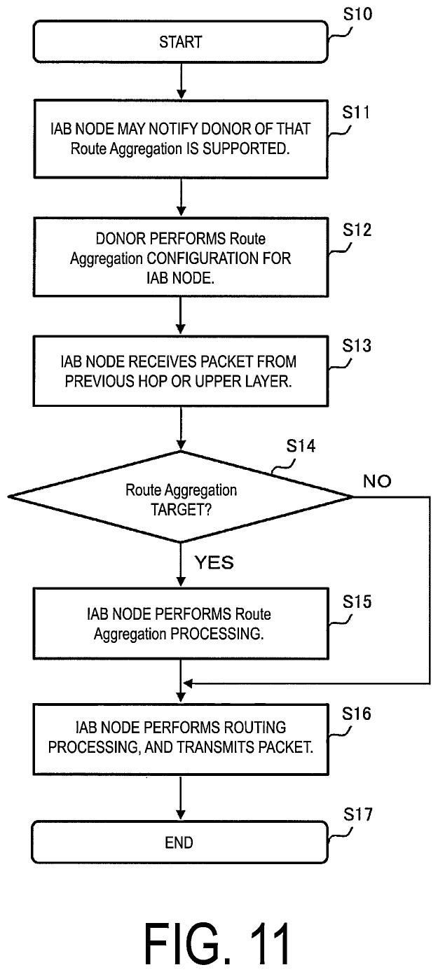

FIG. 11 is a diagram illustrating the operation example according to the first embodiment.

Note that the operation example illustrated in FIG. 11 includes not only an example of the upstream direction, but also an example of the downstream direction. As for the upstream direction, the operation example illustrated in FIG. 11 also includes an operation example of not only the access IAB node 300-A, but also an IAB node 300-T other than the access IAB node 300-A in the upstream direction.

Hence, the following operation example will be described citing an example of the IAB node 300-T as an example of the IAB node. The IAB node 300-T also includes the access IAB node 300-A, the IAB node 300-P1, and the IAB node 300-P2 illustrated in FIGS. 9 and 10.

The IAB node 300-T starts processing in step S10 as illustrated in FIG. 11.

In step S11, the IAB node 300-T may notify the donor node 200 of that route aggregation is supported. For example, the IAB-DU of the IAB node 300-T may transmit an F1AP message including the notification to the CU of the donor node 200 to notify. For example, the IAB-MT of the IAB node 300-T may transmit an RRC message including the notification to the CU of the donor node 200 to notify.

In step S12, the donor node 200 performs a Route Aggregation configuration to the IAB node 300-T. More specifically, the donor node 200 configures association information in which the routing ID (first routing ID) included in a packet received by the IAB node 300-T and the routing ID (second routing ID) indicating an output destination of the packet are associated. The donor node 200 may configure an association table including a plurality of pieces of the association information to the IAB node 300-T.

Here are two patterns for associating two routing IDs.

The first pattern is a pattern for associating a routing ID #1 (first routing ID) and a routing ID #2 (second routing ID). In this case, a BAP packet including the routing ID #1 in a BAP header is a route aggregation target packet. The packet is output to at least one of a next hop node (e.g., IAB node 300-P1) on a path indicated by the routing ID #1 or the next hop node (e.g., IAB node 300-P2) on a path indicated by the routing ID #2.

The second pattern is a pattern for associating a routing ID #A (first routing ID) and the routing ID #1 (second routing ID) and associating the routing ID #A and the routing ID #2 (third routing ID). In this case, a BAP packet including the routing ID #A in a BAP header is a route aggregation target packet. The packet is output to at least one of a next hop node (e.g., IAB node 300-P1) on the path indicated by the routing ID #1 or the next hop node (e.g., IAB node 300-P2) on the path indicated by the routing ID #2.

In addition to the two patterns described above, a third pattern may be considered. The third pattern is a pattern for associating a Secondary Next-hop BAP address with association information (existing) of a routing ID and a Next-hop BAP address. That is, two Next Hop BAP Addresses are associated with one routing ID. In this case, a packet including the routing ID in a BAP header is a route aggregation target packet. The packet is output to the next hop node of at least one of the next-hop BAP address or the secondary next-hop BAP address.

Information included in the route aggregation configuration may further include the followings.

Firstly, a routing ID on an output side may include three or more routing IDs.

Secondly, priority information may be set to each routing ID on the output side. For example, in the second pattern described above, priority information indicating that the routing ID #1 is a primary route and the routing ID #2 is a secondary route may be assigned. For example, in the first pattern described above, a rule may be set that a routing ID of an aggregation target is the primary route and other routing IDs are the secondary routes. The rule may be also information included in the route aggregation configuration.

Thirdly, information indicating whether to perform selective transmission or perform duplication transmission on the aggregation target packet may be included. In the case of selective transmission, a selection criterion or a threshold may be further provided. Selective transmission is to select whether to output a packet to the primary route or output the packet to the secondary route (per packet). Packet duplication is to output the same packet to both of the primary route and the secondary route. Specific examples will be described below.

The route aggregation configuration may be included in, for example, the FIAP message, and transmitted from the CU of the donor node 200 to the IAB-DU of the IAB node 300-T. The route aggregation configuration may be included in, for example, the RRC message, and transmitted from the CU of the donor node 200 to the IAB-MT of the IAB node 300-T.

In step S13, the BAP layer of the IAB node 300-T receives a packet from the previous hop node or the upper layer. The previous hop node may be the parent node 300-P of the IAB node 300-T. In this case, the IAB node 300-T transmits the received packet in the downstream direction. The previous hop node is a child node 300-C of the IAB node 300-T. In this case, the IAB node 300-T transmits the received packet in the upstream direction. A case in which the packet is received from the upper layer is a case in which the IAB node 300-T is the access IAB node 300-A, and a case in which the packet is directly received from the UE 100 and transmitted in the upstream direction. Alternatively, a case in which the packet is received from the upper layer is a case in which the IAB node 300-T is the donor node 200 and a case in which the packet is directly received from the CU of the donor node 200 and transmitted in the downstream direction.

In step S14, the BAP layer of the IAB node 300-T determines whether or not the packet is the route aggregation target based on the association information. More specifically, the BAP layer determines that the packet is the route aggregation target when the association information includes the routing ID included in the BAP header of the packet, and determines that the packet is not the route aggregation target when the routing ID included in the BAP header of the packet is not included in the association information.

In step S14, when the packet is the route aggregation target (YES in step S14), the processing proceeds to step S15. On the other hand, in step S14, when the packet is not the route aggregation target (NO in step S14), the processing proceeds to step S16.

In step S15, the BAP layer of the IAB node 300-T performs rout aggregation processing. The route aggregation processing includes packet sorting processing and header rewrite processing. Firstly, packet sorting processing will be described.

### Packet Sorting Processing

According to the route aggregation processing, the BAP layer of the IAB node 300 performs packet sorting processing and selects at least one of the primary route or the secondary route as a transmission destination of the packet.

The packet sorting processing includes two of a case of selective transmission and a case of duplication transmission. The BAP layer of the IAB node 300 selects whether to perform selective transmission or perform duplication transmission. Firstly, selective transmission will be described.

Selective transmission is to select whether the BAP layer of the IAB node 300-T transmits the packet to the primary route or transmits the packet to the secondary route. More specifically, the BAP layer selects one of the IAB node 300 (e.g., first relay node) on the path indicated by the routing ID of the primary route and the IAB node 300 (e.g., second relay node) on the path indicated by the routing ID of the secondary route.

The routing ID of the primary route and the routing ID of the secondary route also correspond to the two routing IDs associated in the association information included in the route aggregation configuration. In other words, the BAP layer selects the primary route and the secondary route from the two routing IDs associated in the association information. The route aggregation configuration may include which one of the two routing IDs is the primary route and which is the secondary route as the priority information as described above.

The BAP layer may determine the route of the output destination (whether to output the packet to the primary route or output the packet to the secondary route) in accordance with following selection criteria.

Firstly, the BAP layer may determine the route of the output destination based on a data buffer amount of the own node. More specifically, the BAP layer may select the primary route when the data buffer amount of the own node is equal to or less than a threshold (=congestion is not occurring). On the other hand, when the data buffer amount of the own node is equal to or greater than the threshold (=congestion is occurring), the BAP layer may select the primary route or the secondary route (per packet) or may select only the secondary route.

Secondly, the BAP layer may determine the route of the output destination based on the buffer amount of the next hop node. More specifically, when an available buffer size included in a flow control feedback notified from the parent node 300-P of the IAB node 300-T or the child node 300-C of the IAB node 300-T is equal to or greater than the threshold (i.e., congestion is not occurring), the BAP layer may select the primary route. On the other hand, when the available buffer size is equal to or less than the threshold (=congestion is occurring), the BAP layer may select the primary route or the secondary route (per packet) or may select only the secondary route.

Thirdly, the BAP layer may determine the route of the output destination based on a throughput. More specifically, the BAP layer may select the primary route when the output throughput is equal to or greater than the threshold (=congestion is not occurring). On the other hand, when the output throughput is equal to or less than the threshold (=congestion is occurring), the BAP layer may select the primary route or the secondary route (per packet) or may select only the secondary route.

Fourthly, the BAP layer may determine the route of the output destination based on a fixed ratio. More specifically, the BAP layer selects the primary route or the secondary route (per packet) in accordance with the fixed ratio. When, for example, the ratio of the primary route and the secondary route is set to the fixed ratio of 70:30, the BAP layer selects packets such that 70% of the packets are output to the primary route and 30% of the packets are output to the secondary route. The fixed ratio may be part of information included in the route aggregation configuration described above.

Packet duplication included in the sorting processing will be described. Packet duplication is more specifically processing in which the BAP layer selects both of a first IAB node (e.g., first relay node) on the first path indicated by the first routing ID and a second IAB node (e.g., second relay node) on the second path indicated by the second routing ID. Hence, the BAP layer performs processing of duplicating the packet. That is, the BAP layer duplicates a predetermined number (=(the number of routes of output destination)−1) of packets. The BAP layer selects a route of the output destination. There may be two or more routes of the output destination. The BAP layer selects all of the routing IDs (e.g., the routing ID #1 and the routing ID #2) on the output side included in the association information as routes of the output destination for the route aggregation target packet.

### Header Rewrite Processing

Header rewrite processing included in the route aggregation processing will be described. The header rewrite processing is processing of rewriting the routing ID (e.g., first routing ID) included in the packet to the routing ID (e.g., the second routing ID or the third routing ID) of the route selected by the sorting processing.

When, for example, the packet includes the routing ID #1 (e.g., first routing ID), and the route of the routing ID #2 (e.g., second routing ID) is selected by the sorting processing, the BAP layer rewrites the routing ID of the packet from the routing ID #1 to the routing ID #2. When, for example, the packet includes the routing ID #A (e.g., first routing ID) and the route of the routing ID #2 (e.g., third routing ID) is selected by the sorting processing, the BAP layer rewrites the routing ID of the packet from the routing ID #A to the routing ID #2.

Firstly, when the routing ID included in the packet and the routing ID of the selected route are the same, the BAP layer may skip the header rewrite processing. When, for example, the packet includes the routing ID #1 and the route of the routing ID #1 is selected by the sorting processing, the BAP layer may skip the header rewrite processing.

Secondly, in the case of duplication transmission, the BAP layer rewrites, to the routing ID of the selected route, each packet to be transmitted to each route. When, for example, the packet includes the routing ID #1 and duplication transmission is performed to the route of the routing ID #1 and the route of the routing ID #2, the BAP layer is as follows. That is, the BAP layer performs header rewriting of rewriting, to the routing ID #1, a packet to be transmitted to the route of the routing ID #1, and performs header rewriting of rewriting, to the routing ID #2, a packet to be transmitted to the route of the routing ID #2. The BAP layer performs header rewriting of rewriting, to the routing ID #3, a packet to be transmitted by duplication transmission to the route of the routing ID #3.

Thus, the BAP layer ends the route aggregation processing.

In step S16, the BAP layer of the IAB node 300-T performs routing processing and BH RLC channel mapping processing, and transmits the packet to the next hop node. More specifically, the BAP layer identifies a Next-hop BAP address associated with the routing ID by the routing processing, and identifies an egress link. The BAP layer identifies a BH RLC channel associated with the egress link by the BH RLC channel mapping processing. Then, the BAP layer transmits the packet to the BH RLC channel. Thus, the packet is transmitted to the next hop node (e.g., at least one of the first relay node or the second relay node).

In step S17, the series of processing operations is ended.

In the embodiment described above, the method for associating the first routing ID and the second routing ID has been described. The destination BAP address included in the routing ID may be the same during route aggregation. Accordingly, instead of associating routing IDs, path IDs may be associated. That is, the donor node 200 sets an association between the first path ID and the second path ID to the IAB node 300-T. In this case, the association information is information in which the first path ID and the second path ID are associated.

### Second Embodiment

A second embodiment will be described. In the first embodiment, an example has been described in which the BAP layer performs the route aggregation processing in accordance with the route aggregation configuration. The second embodiment is an example in which the donor node 200 dynamically changes the route aggregation configuration for the IAB node 300-T.

More specifically, the donor node (e.g., donor node 200) instructs the route aggregation processing to the relay node (e.g., IAB node 300-T). Here, the instruction is at least one selected from the group consisting of designation of a route of the output destination, designation of start and/or stop of selective transmission, and designation of start and/or stop of duplication transmission. Specific instruction contents will be described in an operation example.

The donor node 200 can dynamically change the route aggregation configuration in accordance with the instruction.

### Operation Example According to Second Embodiment

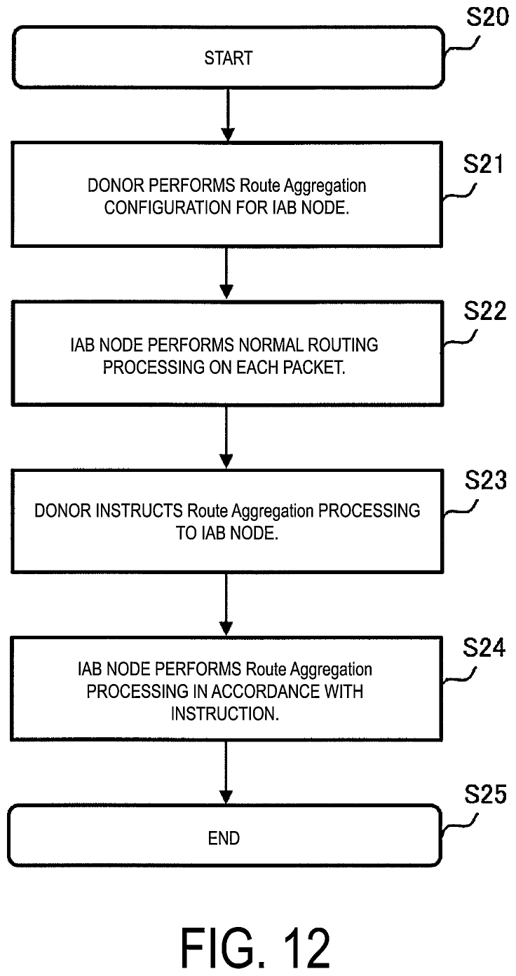

FIG. 12 is a diagram illustrating an operation example according to the second embodiment. As illustrated in FIG. 12, in step S20, the donor node 200 starts processing.

In step S21, the donor node 200 sets the route aggregation configuration to the IAB node 300-T. The route aggregation configuration is the same as and/or similar to that in the first embodiment. The donor node 200 may designate default settings of the route aggregation processing in the route aggregation configuration. For example, as default settings, the donor node 200 may include information indicating that the route aggregation configuration is configured, but the route aggregation processing is not performed (=the same operation as that in a case in which the route aggregation is not configured is performed) in the route aggregation configuration. The following operation example will be described assuming that the route aggregation configuration is configured, but not performing the route aggregation processing is designated as the default settings.

In step S22, the IAB node 300-T performs normal routing processing and BH RLC channel processing on each received packet, and transmits each packet to the next hop node.

In step S23, the donor node 200 instructs the route aggregation processing to the IAB node 300-T.

An RRC message or a BAP Control PDU may include the instruction. For example, the CU of the donor node 200 may transmit the RRC message including the instruction to the IAB-MT of the IAB node 300-T. For example, the DU of the donor node 200 may transmit the BAP Control PDU including the instruction to the IAB-MT of the IAB node 300-T. The instruction may have a command format. The instruction may be included in the F1AP message. The contents of the instruction may be at least one of the followings.

That is, firstly, the contents of the instruction may be start and stop of the route aggregation processing. More specifically, the contents of the instruction are as follows. That is, the contents of the instruction may be start and stop of selective transmission described in the first embodiment. The contents of the instruction may be start and stop of duplication transmission described in the first embodiment. The contents of the instruction may be represented by a choice syntax for selecting one of selective transmission, duplication transmission, and no processing.

Secondly, the contents of the instruction may be designation of a route of the output destination. More specifically, the contents of the instruction are as follows. That is, the contents of the instruction may designate whether the route of the output destination is the primary route or the route of the output destination is the secondary route (or whether or not both of the primary route and the secondary route are the routes of the output destination). The contents of the instruction may designate a routing ID indicating a route of the output destination. The contents of the instruction may designate a next hop address indicating a route of the output destination. The contents of the instruction may be designation of a route of the output destination for the routing ID of the aggregation target. That is, the contents of the instruction may be an instruction of route aggregation processing per routing ID.

The donor node 200 may transmit the instruction by being triggered by followings.

That is, firstly, load dispersion is used as a trigger. More specifically, the load dispersion is as follows. That is, the donor node 200 may transmit the instruction by being triggered by detection of occurrence of congestion in a certain route. The donor node 200 may transmit the instruction by being triggered by detection of load imbalance in the certain route. In this case, the donor node 200 may determine that the load is imbalanced when a difference in load between the certain route and another route is equal to or greater than a certain degree. Secondly, communication characteristics are used as a trigger. More specifically, the donor node 200 may transmit the instruction when it is detected that packet loss occurs in the certain route, a throughput of the certain route lowers to a certain value or less, or delay of the certain route is increased to a certain value or more.

Thirdly, the donor node 200 may transmit the instruction by being triggered by occurrence of a state opposite to the state described for the above-described trigger condition of load dispersion. The donor node 200 may transmit the instruction by being triggered by occurrence of a state opposite to the state described for the trigger condition of the communication characteristics. For example, the donor node 200 may transmit the instruction by being triggered by detection that congestion in the certain route has been resolved. In this case, when, for example, detecting the occurrence of congestion, the donor node 200 may transmit the instruction including the instruction contents indicating start of the route aggregation processing, and, when detecting that congestion has been resolved, the donor node 200 may transmit the instruction including the instruction contents indicating stop of the route aggregation processing.

In step S24, the IAB node 300-T receives the instruction, determines whether to start or stop the route aggregation processing in accordance with the contents of the instruction, and determines how to perform the route aggregation processing in accordance with the contents of the instruction. When, for example, the instruction contents include start of selective transmission and the primary route, the IAB node 300-T determines to start the route aggregation processing, and determines to perform selective transmission to the primary route as the route aggregation processing. The IAB node 300-T performs the route aggregation processing in accordance with the determination. The following processing is the same as and/or similar to that of the first embodiment.

In step S25, the series of processing operations is ended.

### OTHER EMBODIMENTS

A program causing a computer to execute each processing performed by the UE 100 or the gNB 200 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM.

Circuits for executing each processing performed by the UE 100 or the gNB 200 may be integrated, and at least a part of the UE 100 or the gNB 200 may be implemented as a semiconductor integrated circuit (chipset, system on a chip (SoC)).

Embodiments have been described above in detail with reference to the drawings, but specific configurations are not limited to those described above, and various design variation can be made without departing from the gist of the present disclosure. Each of the above-described embodiments, each operation example, each processing, or each step can be appropriately combined as long as no inconsistencies are introduced.

The phrases “based on” and “depending on” used in the present disclosure do not mean “based only on” and “only depending on,” unless specifically stated otherwise. The phrase “based on” means both “based only on” and “based at least in part on”. The phrase “depending on” means both “only depending on” and “at least partially depending on”. “Obtain” or “acquire” may mean to obtain information from stored information, may mean to obtain information from information received from another node, or may mean to obtain information by generating the information. The terms “include”, “comprise” and variations thereof do not mean “include only items stated” but instead mean “may include only items stated” or “may include not only the items stated but also other items”. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

### Supplementary Note

Features relating to the embodiments described above are described.

(1)

A communication control method used in a cellular communication system includes:
configuring, at a donor node, association information of a first routing ID included in a packet and a second routing ID indicating an output destination for a relay node; and
transmitting, at the relay node, the packet to at least one of a first relay node on a first path indicated by the first routing ID or a second relay node on a second path indicated by the second routing ID in accordance with the association information.
   (2)

According to the communication control method described in above (1), transmitting the packet further includes:
determining, at the relay node, whether or not the packet is a route aggregation target, based on the association information; and transmitting, at the relay node, the packet determined to be route aggregation target, in accordance with the association information.
   (3)

According to the communication control method described in above (1), transmitting the packet includes performing, at the relay node, sorting processing, and
performing the sorting processing includes
performing, at the relay node, selective transmission of selecting one of the first relay node and the second relay node, and
performing, at the relay node, duplication transmission of selecting both of the first relay node and the second relay node.
   (4)

According to the communication control method described in above (1),
transmitting the packet includes performing, at the relay node, header rewrite processing, and
performing the header rewrite processing includes rewriting, at the relay node, the first routing ID to one of the second routing ID and a third routing ID.
   (5)

According to the communication control method described in above (4), performing the header rewrite processing includes not rewriting, at the relay node, a routing ID included in a header of the packet to the first routing ID when the routing ID is the first routing ID.

(6)

The communication control method described in above (3) further includes instructing, at the donor node, route aggregation processing to the relay node, and the instruction is at least one selected from the group consisting of designation of a route of an output destination, designation of start and/or stop of the selective transmission, and designation of start and/or stop of the duplication transmission.

### REFERENCE SIGNS

1: Mobile communication system
10: 5GC
100: UE
110: Wireless communicator
130: Controller
200: Donor node (gNB)
210: Wireless communicator
230: Controller
300 (300-T, 300-A, 300-P1, 300-P2): IAB node
310: Wireless communicator
320: Controller

1. A communication control method used in a cellular communication system, the method comprising:
configuring, by a donor node, association information of a first routing ID included in a packet and a second routing ID indicating an output destination for a relay node; and
transmitting, by the relay node, the packet to at least one of a first relay node on a first path indicated by the first routing ID or a second relay node on a second path indicated by the second routing ID in accordance with the association information, wherein
the transmitting includes transmitting, by the relay node, a first packet of the packet to the first relay node and a second packet of the packet to the second relay node, in accordance with the association information, and
the transmitting the first packet to the first relay node and the transmitting the second packet to the second relay node are performed simultaneously.

2. The communication control method according to claim 1, wherein the transmitting the packet include:
determining, by the relay node, whether or not the packet is a route aggregation target, based on the association information; and
transmitting, by the relay node, the packet determined to be the route aggregation target, in accordance with the association information.

3. The communication control method according to claim 1, wherein
the transmitting the packet includes performing, by the relay node, sorting processing, and
the performing the sorting processing includes
performing, by the relay node, duplication transmission of selecting both of the first relay node and the second relay node.

4. The communication control method according to claim 1, wherein
the transmitting the packet includes performing, by the relay node, header rewrite processing, and
the performing the header rewrite processing includes rewriting, by the relay node, the first routing ID to one of the second routing ID and a third routing ID.

5. The communication control method according to claim 4, wherein the performing the header rewrite processing includes not rewriting, by the relay node, a routing ID included in a header of the packet to the first routing ID in response to the routing ID being the first routing ID.

6. The communication control method according to claim 3, the method further comprising instructing, by the donor node, route aggregation processing to the relay node,
wherein the instruction is at least one selected from the group consisting of designation of a route of an output destination, designation of start and/or stop of the selective transmission, and designation of start and/or stop of the duplication transmission.

7. The communication control method according to claim 3, wherein
the instructing includes instructing, by the donor node, start or stop of the route aggregation after routing processing is performed by the relay node,
the instructing start or stop of the route aggregation includes one of the selective transmission, the duplication transmission, and no processing,
in case of instructing the selective transmission, the instructing start or stop of the route aggregation includes,
instructing, by the donor node, that the route of the output destination is a primary route or a secondary route, or
instructing, by the donor node, a routing ID indicating the route of the output destination, and
in case of instructing the duplication transmission, the instructing start or stop of the route aggregation includes,
instructing, by the donor node, the primary route and the secondary route as the route of the output destination, or
instructing, by the donor node, a plurality of routing IDs indicating the route of the output destination.

8. The communication control method according to claim 1, wherein
the configuring includes configuring, by the donor node, priority information to the first routing ID and the second routing ID.
